(19) United States
(12) Patent Application Publication
(10) Pub. No.: US 2013/0207400 A1
(43) Pub. Date: Aug. 15, 2013

(54) ENERGY STORAGE AND DRIVE DEVICE

(71) Applicant: Al-Jobory Fawaz Saleem Hassan, Sharjah (AE)

(72) Inventor: Al-Jobory Fawaz Saleem Hassan, Sharjah (AE)

(21) Appl. No.: 13/880,654

(22) PCT Filed: Sep. 28, 2011
(86) PCT No.: PCT/IB11/02275

§ 371 Date: Apr. 19, 2013

(51) Int. Cl. H02K 7/18

(52) U.S. Cl. CPC H02K 7/1853
USPC 290/1 E

(57) ABSTRACT

A Mechanical Energy Storage and Drive Device, The device stores elastic energy in its storage equipment (The springs) and creating resonance/pendulum phenomena inside its equipment (the springs and its coupled mass) after releasing the charged springs by using continuous external energy source feeds the electric motor/solenoid that produce the small vibrated power applied on the springs and its coupled mass for creating the resonance/pendulum phenomena inside the device.

After releasing the springs the stored elastic energy will be converted to kinetic and potential energy. So, the main advantages for creating resonance/pendulum phenomena inside the device after releasing the springs are;
1. Keeps storing the Kinetic & potential energy inside the device/springs at No-Load condition.
2. As consequences, consumption and convert the stored kinetic and potential energy into electric energy via electric generator gradually and smoothly at toad condition and in accordance to/proportional to the connected load power, wherein the low power load will consumption the stored power at longer time period, while the high power load will consumption the stored kinetic and potential energy at shorter period.
   the current invention device has energy storage equipment (The springs coupled to mass) associated with mechanical compression, support and release mechanisms, supplementary linear electric Motor/Solenoid connected to external electric energy source output terminals via Voltage regulator and micro switch (Bell Type Switch), electric generator and electric convertor.

The springs that stores stored energy. The springs system has an input for storing elastic energy via compression/charging mechanism (The Jack/Hydraulic system) that operates in response to external force/energy such as renewable energy sources (sea waves, Stream River, wind turbine) or human body force or any energy sources able to produce mechanical energy that can be coupled to the input of the compression/charging mechanism and has another input connected to external electric power source via supplementary linear electric Motor/Solenoid for applying periodic vibrated force/energy on the mass after charging, holding and releasing the springs system to create resonance phenomena on the springs system and its coupled mass and has an output for releasing the stored elastic energy in response to external force wherein the resonance phenomena keeps storing the kinetic and potential energy inside the springs at No-Load condition after releasing the stored elastic energy. Permanent magnet electrical generator consumption and converts the stored kinetic and potential energy inside the springs into electric energy at Load condition gradually and smoothly in accordance to/proportional to the connected load power. The generated electrical power feeds electrical loads via an electric convertor.

### FIELD OF INVENTION

The invention is related to convert the energy stored in charged springs system into:

1- Electric power.

2- Pushing force.

The generated electric power feeds electric loads and charges the supplementary Battery. The supplementary Battery supplies/feeds the supplementary linear D.C. electric motor via electric regulator and micro switch. The supplementary linear D.C. electric motor converts the generating electrical power into magnetic field power (pushing force) in response to operation of micro switch, Wherein The magnetic field power (pushing force) in a frequency equal to the natural frequency of the oscillated springs system after releasing. The magnetic field power (pushing force) applied to the springs system coupled and drives the permanent magnet armature of the linear electric power generator in linear velocity causes continuous oscillation of the springs system and continuously generating of electric power.

### BACKGROUND OF THE INVENTION

Electric power generating plants in our practical life are divided to two major types, hydraulic power plants and fossil fuel power plant which has adverse effect on the environment, for example electric power generating system that utilize fossil fuels such as coal or oil produce residual materials which pollute the atmosphere. those pollutant result from the burning of fossil fuels to generate heat to produce steam which operates turbines that drive electric power generating system or using gas turbine to drive electric power generating system. Nuclear plants are a kind of fossil fuel power plant. the hydraulic electric power plants system require expensive and elaborate structures, such as dams, which block rivers and water storage pond and lakes, which can adversely impact the environment.

Car engine which work on the petrol fuel has adverse effect on the environment and adverse cost effect due to increase on consumption and price of the fuel.

Attempts has been made to utilize alternative natural energy sources such as solar energy, wind power and sea wave power to produce electricity from their unlimited source of natural power. Still most of these systems are expensive compared to the electricity produce by fossil fuel.

The present invention has made to develop system for generating electricity that eliminate or minimize the disturbance of the environment and the high expenses and ecological problems.

### SUMMARY OF THE INVENTION

The present invention system can be arrangement/assembly in many models and types related to the structure design; all of these models and types have the same function and operation method for converting the energy stored in charged springs system into a self-sustaining electric power.

The generating electric power can feed deferent types of electric loads which cover domestic and industry electric loads. The further descriptions of the present invention are in the following brief description of the drawings, the detailed description of the invention and the claims.

Other features and advantages of the present invention will become apparent from the following detailed description of the invention made with reference to the accompanying drawings.

### BRIEF DESCRIPTION OF THE DRAWINGS

FIG. (1/15) Representing a block diagram shown that the electric power generating method and operation of a self-sustaining electrical power generating system compressed of a permanent magnet linear electric generator, springs system, compression and releasing mechanical mechanisms and supplementary linear D.C. electric motor, Battery and micro switch.

FIG. (2/15) presents a detailed drawing (1) of a self-sustaining electric power generating system compressed of a permanent magnet linear electric generator, springs system, compression and releasing mechanical mechanisms and supplementary linear D.C. electric motor, Battery and micro switch.

FIG. (3/15) presents a detailed drawing (2) of a self-sustaining electric power generating system compressed of a permanent magnet linear electric generator, springs system, compression and releasing mechanical mechanisms and supplementary linear D.C. electric motor, Battery and micro switch.

FIG. (4/15) presents a Simulated sample representing a springs system (response and characteristic) of the present invention system. (a self-sustaining electric power generating system).

FIG. (5/15) presents a Mathematic related formula of the simulated sample representing a springs system (response and characteristic) of the present invention system (a self-sustaining electric power generating system).

FIG. (6/15) presents a linear D.C. electric motor converts the electric power to pushing and pulling force of the present invention system (a self-sustaining electric power generating system) includes supplementary linear D.C. electric motor, Battery and micro switch.

FIG. (7/15) presents a Methods and sequence of operation for the electrical power generating system compressed of a linear electric generator, springs system, compression and releasing mechanical mechanisms and supplementary linear D.C. electric motor, Battery and micro switch.

FIG. (8/15) Representing a flow chart shown that the electric power generating method and operation of the present invention system (a self-sustaining electrical power generating system compressed of a permanent magnet linear electric generator, springs system, compression and releasing mechanical mechanisms and supplementary linear D.C. electric motor, Battery and micro switch)

FIG. (9/15) presents a model-B-detailed drawing of the present invention system (a self-sustaining electric power generating system compressed of a permanent magnet linear electric generator, springs system, compression and releasing mechanical mechanisms and supplementary linear D.C. electric motor and micro switch

FIG. (10/15) presents a model-C-detailed drawing of the present invention system (a self-sustaining electric power generating system compressed of a permanent magnet linear electric generator, springs system, compression and releasing mechanical mechanisms and supplementary linear D.C. electric motor and micro switch.

FIG. (11/15) presents a model-D-detailed drawing of the present invention system (a self-sustaining electric power generating system compressed of a permanent magnet linear electric generator, springs system, compression and releasing mechanical mechanisms and supplementary linear D.C. electric motor and micro switch.

FIG. (12/15) presents a model-E-detailed drawing of the present invention system (a self-sustaining electric power generating system compressed of a permanent magnet linear electric generator, springs system, compression and releasing mechanical mechanisms and supplementary linear D.C. electric motor and micro switch.

FIG. (13/15) presents a model-F-detailed drawing of the present invention system (a self-sustaining electric power generating system compressed of a permanent magnet linear electric generator, springs system, compression and releasing mechanical mechanisms and supplementary linear D.C. electric motor and micro switch.

FIG. (14/15) presents a model-G-detailed drawing of the present invention system (a self-sustaining electric power generating system compressed of a permanent magnet linear electric generator, springs system, compression and releasing mechanical mechanisms and supplementary linear D.C. electric motor.

FIG. (15/15) presents an Electric Generating Engine includes multi electric power generating systems

### DETAIL DESCRIPTION OF THE INVENTION

The present invention is an economical way to produce a self-sustaining electrical energy without adversely impacting the environment, without utilizing fossil fuel and without the need to construct large structures. The present invention system can construct/manufactured with wide range of models, sizes and capacities covering the domestic and industry demand of electric power.

The present invention system is providing a consistent basis energy source for operating a permanent magnet linear electrical generator by using the mechanical force of metals springs.

The present invention system includes the following main parts/equipments:

1. Stainless steel fixed supporting/housing frame.

2. Permanent magnet linear electric generator.

3. Springs system.

4. Mechanical compression/charging mechanism.

5. Mechanical support and release mechanism.

6. Main electric convertor.

7. Supplementary rectifier.

8. Supplementary storage energy equipment (Battery).

9. Supplementary Electric regulator.

10. Micro switch.

11. Supplementary linear D.C. electric motor.

12. Circuit breaker.

13. Earth system.

FIG. (1/15) presents a block diagram representation of a self-sustaining electric power generating system of the present invention.

The self-sustaining electric power generator system includes a springs system (103) that stores stored energy in the springs. The springs system has an input for charging the stored energy (one time only at starting) and an output for releasing the stored energy.

In operation, the compression/charging mechanical mechanism (101) moves in response to external force (00a) and compress/charges the stored energy (one time only at starting) in the springs system (103). the springs system (103) releases the stored energy and starts the linear oscillation (extension and compression) movement (03) in response to mechanical release signal (02) generated by a support/release mechanical mechanism (102), wherein the generated release signal (02) is generated (one time only at starting) in response to external force (00b). A permanent magnet linear electric generator (104) is coupled to the output of the springs system (103). A permanent magnet linear electric generator (104) converts the released stored energy (03) of the springs system (103) into electric power (04). a main electric convertor (105) has an input connected to a permanent magnet linear electric generator (104). a main electric convertor (105) converts the generated electric power (04) into regulated/converted electric power signal (05) that match and feeds the electric loads (106). the supplementary electric rectifier (107) has an input connected to a permanent magnet linear electric generator (104). the supplementary electric rectifier (107) convert the alternating electric power signal (04) into D.C. electric signal (07) that charges the supplementary Battery (108). the supplementary Battery (108) terminals are connected to the output of the supplementary electric rectifier (107) and input of the supplementary electric regulator (109). the supplementary regulator output feeds and controls the linear D.C. electric motor (111) via a micro switch (normally open) (110), wherein the regulated D.C. electric signal (10) feeds the Linear D.C. electric motor in accordance to operation of the micro switch (110). The linear D.C. electric motor (111) has an output coupled to the springs system (103). The supplementary linear D.C. electric motor (111) converts the regulated D.C. electric power signal (10) into pushing force (11) in a frequency equal to the natural frequency of the oscillated springs system after releasing. The magnetic field power pushing force (11) applied to the input of the springs system coupled and drives the permanent magnet armature of the linear electric power generator in linear velocity causes continuous oscillation (extension and compression) movement of the springs system (103) and continuously generating of electric power signal (04).

FIG. (2A) 2/15 and FIG. (3A) 3/15 presents detail drawings of Model (A) of the present invention system under steady state condition (normal position) shown that includes the followings parts/equipments:

Springs System.

The springs system stores stored energy in the springs. The springs system has an input for charging the stored energy (one time only at starting) and an output for releasing the stored energy (one time only at starting).

The springs system includes four springs (8a,8b,8c,8d), one side of the springs is connected to the fixed frame (2a) another side of the springs is connected to the movable metal plate (5) compressed with two bearings (24a,24b) and a linear D.C. electric motor movable shaft (4). the discharged/released energy of the springs (8a, 8b, 8c, 8d) makes the two bearings (24a,24b) of the springs system coupled to permanent magnet armature (6) of the linear electric generator swings in fixed metal rail (25) and the springs system moves in linear extension and compression movement.

One Side (Top Side) Compression/Charging Mechanical Mechanism

The compression/charging mechanical mechanism compress/charges the stored energy (one time only at starting) in the springs system. The compression/charging mechanical mechanism includes (U) shape metal frame (18), foot lever (14) and hydraulic jack (17).

The compression/charging mechanical mechanism fixed inside the housing metal frame,

The compression/charging mechanical mechanism moves up to compresses/charges the springs systems (one time only at starting) in response to external force (19) applied to the foot leaver (14). The compression/charging mechanical mechanism manually returned back to its normal position after full compression of the springs system that hanged and fixed by the support/release mechanical mechanism.

Support/Release Mechanical Mechanism

The support/release mechanical mechanism supports/fixes the charged/compressed springs system in fully compression position. The springs system released in response to the pushing force applied to the mechanical push button (15). The support/release mechanical mechanism includes a hand lever (26) fixed to metal arrow (20b), the metal arrows (20a,21a,20b,21b) fixed to housing frame through the torsion springs (22a, 23a, 22b, 23b), a metal rods transducer (26a, 26b) fixed to metal arrows(20a, 20b, 21a, 21b) in one degree of freedom point and a mechanical push button (15). The mechanical push button (15) releases the torsion springs (22a, 23a, 22b, 23b) and makes the metal arrows (20a, 21a, 20b, 21b) return back to its normal position and release the springs system.

Permanent Magnet Linear A.C. Electric Generator

The Permanent magnet linear electric generator converts the released stored energy/linear oscillation (extension and compression) movement of the springs system into output electric power. The Permanent magnet linear electric generator includes a permanent magnet armature (6) and stator (7) that includes insulated copper winding and its terminals (9).

The permanent magnet armature (6) Hanged/coupled to the movable plate (5) of the springs system, wherein the movable plate (5) of the spring's system drives the permanent magnet armature (6) in linear movement (velocity). The stator (7) fixed to the housing frame (2b). The linear movement of the Permanent magnet armature (6) inside the stator intersects the magnetic field of the armature (6) with the stator copper windings and generates electric voltage at the end terminals of the stator insulated copper windings (9).

Electric Circuit Breaker (10).

The electric circuit breaker (10) controls the generated electric power and protects the stator insulated copper windings agents the over load and over current. The input terminals of the electric circuit breaker (10) is connected to the terminals of the stator winding (9) while the output terminals is connected to the input of the main electric convertor (12) and supplementary electric regulator (16).

Main Electric Convertor (12) Equipped with Over Voltage Protection.

The main electric convertor (12) converts and regulates the electric power (frequency and voltage) to match and feed the electric loads. The Main electric convertor includes over voltage protection, input terminals connected to the output of the circuit breaker (10) via the PVC copper wires (11) while the output terminals is connected to the electric loads.

Supplementary Electric Rectifier (16a) Equipped with Over Voltage Protection.

The supplementary electric rectifier (16a) rectifies/converts the generated output alternating electric power into D.C. electric power and feeds it to the supplementary Battery (16b).

The Supplementary electric rectifier (16a) includes over voltage protection, input terminals connected to the output terminals of the circuit breaker (10) through the insulated copper wires (3a) while the output terminals is connected to the terminals of the supplementary Battery (16b).

Supplementary Storage Energy Equipment (Battery) (16b).

The supplementary Battery (16b) is a supplementary energy source that supplies and feeds the linear D.C. electric motor (1) via electric regulator (16) and micro switch (16c).

The supplementary Battery (16b) includes terminals connected to the output terminals of the rectifier (16a) and input terminals of the supplementary regulator (16) via the insulated copper rod (3b).

Supplementary Electric Regulator (16) Equipped with Over Voltage Protection.

The supplementary electric regulator (16) regulates and controls the electric power manually/automatically and feeds it to the linear D.C. electric motor (1) in accordance to operation of the micro switch (16c). The Supplementary electric regulator (16) includes over voltage protection, input terminals connected to the supplementary Battery (16b) terminals via the insulated copper rod (3b) while the output terminals is connected to the input terminals of the linear D.C. electric motor (1) via the micro switch (16c).

Supplementary Micro Switch (16c) (Normally Open).

The supplementary micro switch (16c) connects and disconnects the D.C. electric power of the supplementary battery (16b) that feeds the linear D.C. electric motor, wherein the operation (connecting/disconnecting) of the micro switch (16c) in accordance to the springs system linear movement. The supplementary micro switch (16c) includes input terminal connected to the positive terminal of the electric regulator (16) via the insulated copper wires (3c) and output terminal connected to the linear D.C. electric motor terminal via the insulated copper wires (3d).

Supplementary Linear D.C. Electric Motor.

The linear D.C. electric motor (1) fixed on the housing frame (2a) converts the D.C. electric power into magnetic field power (pushing force) between The linear D.C. electric motor (1) and his movable shaft (4) fixed on the movable metal plate (5) in response to the operation of the micro switch (16c), wherein the generated magnetic field (pushing force) acts as an applied force to the springs system with frequency equal to the natural frequency of the springs system that makes the springs system under continuous linear oscillation (extension and compression) movement. The continuous linear oscillation (extension and compression movement) of the springs system coupled to and drives the permanent magnet armature (6) of the linear electric generator in linear velocity causes continuous generating of electric power.

The linear D.C. electric motor (1) input is connected to the output of the supplementary electric regulator (16) via insulated copper wires (3d,3c) and micro switch (16c).

Earth System.

The earth system protects the present invention system and human body from electrical leakage. All equipments for the present invention system are earthed and connected to the earth point (13) through insulated copper wires and copper rod fixed in the ground.

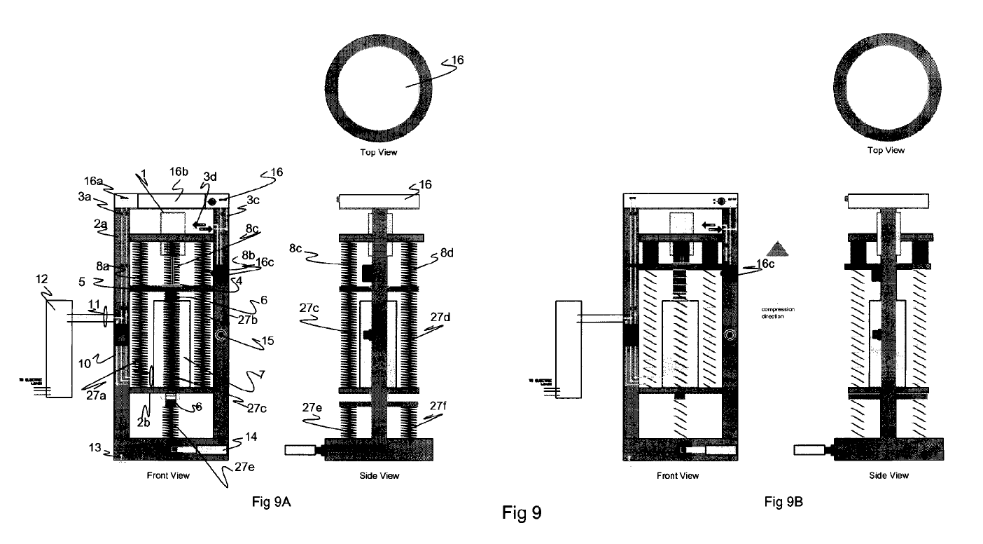

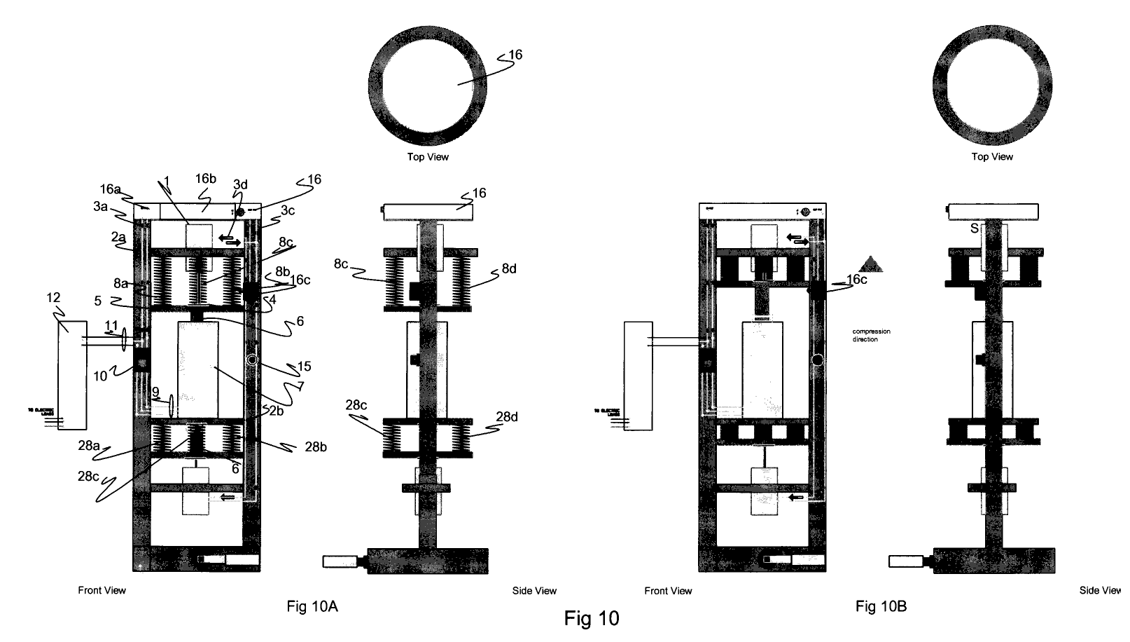

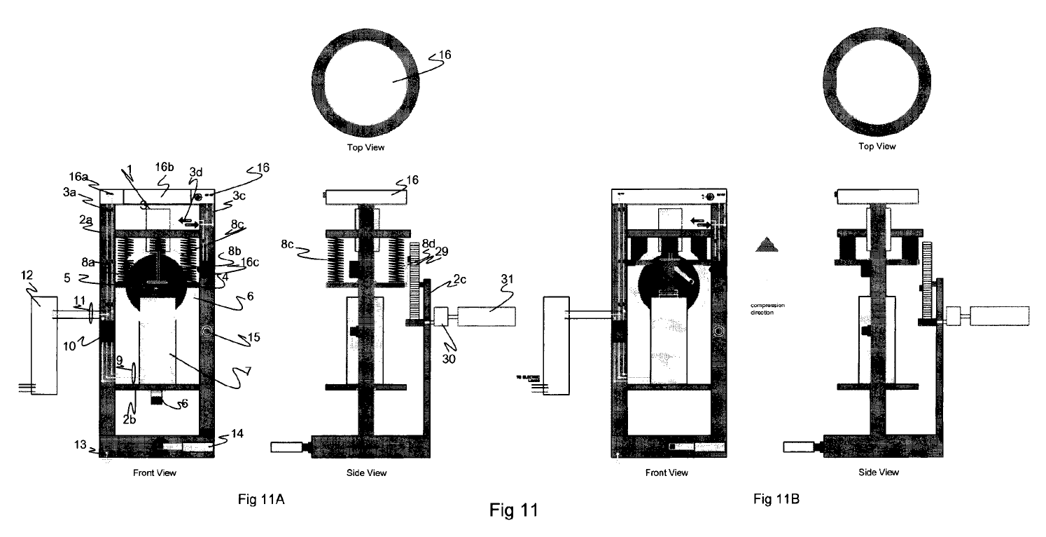

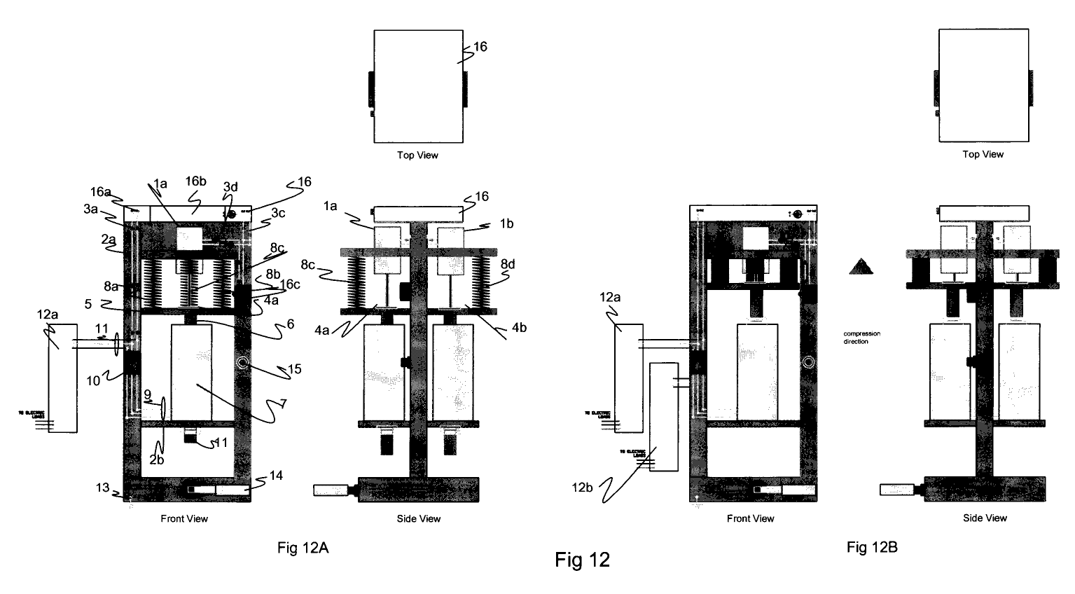

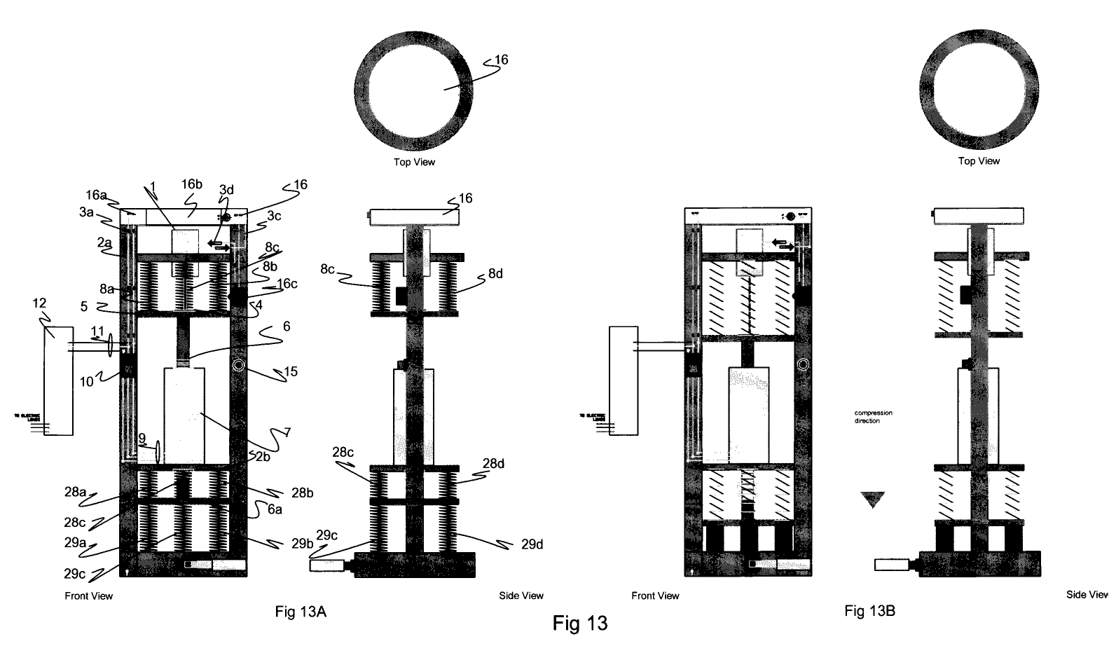

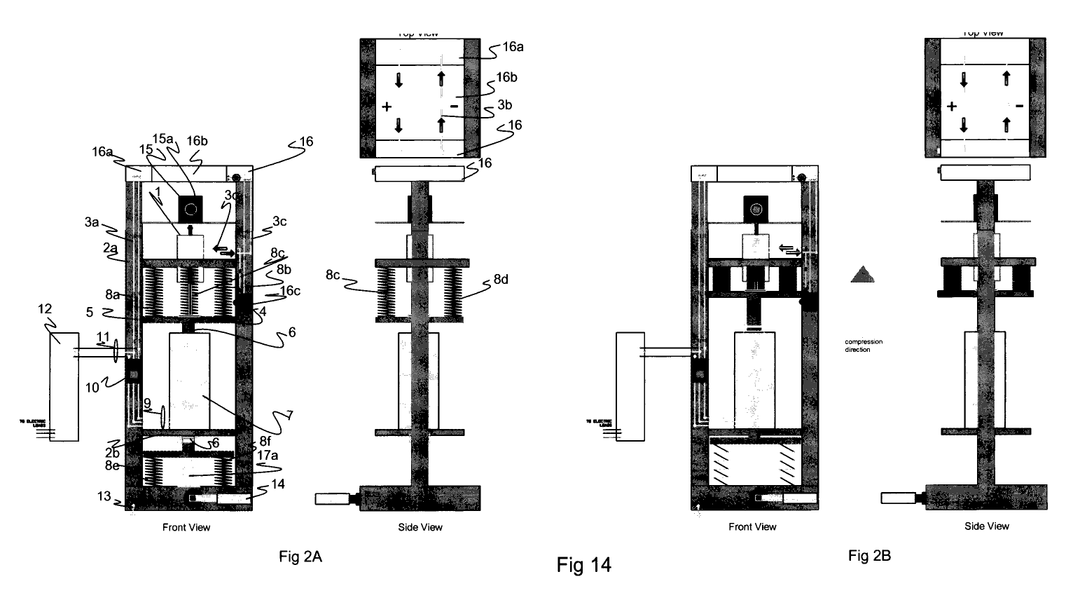

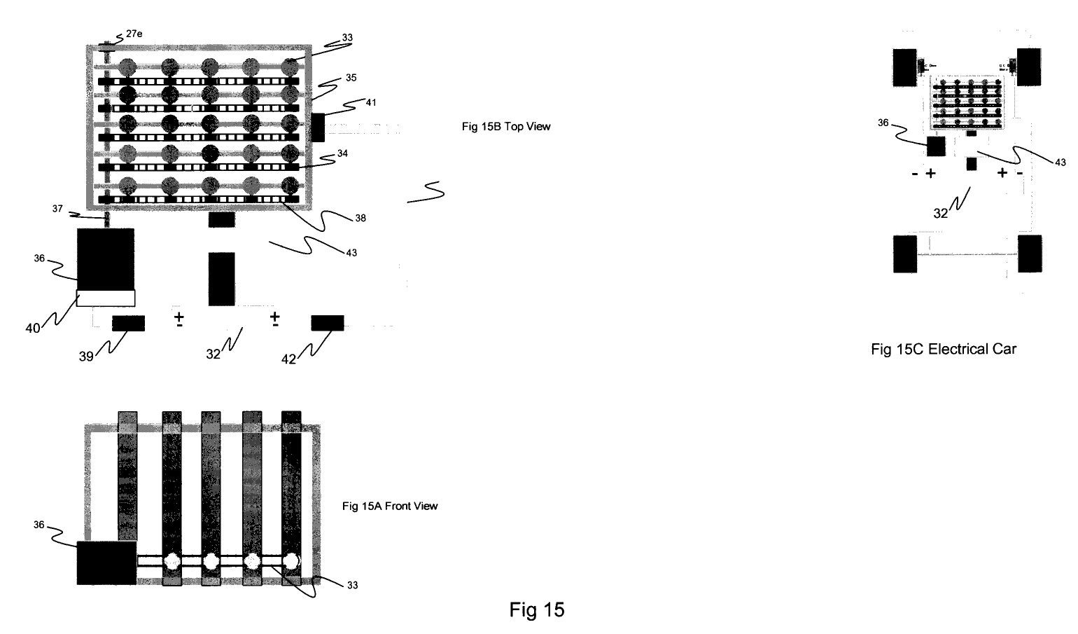

NOTE: all arrows shown in the figures/drawings are just for indication of the supplementary currents direction after releasing the springs from up to down and pushing the micro switch (16c) lead. For the actual current flow direction, Please refer to FIG. 7/15

In operation, the hand lever (26) is moved (90 degree) manually (one time only at starting) in a clockwise direction that makes the metal arrow (20b) moved toward the metal arrow (21b). A metal rods (26a, 26b) transducer transfers the movement of metal Arrow (20b) and metal arrow (21b) to the metal arrow (20a) and metal arrow (21a). a metal arrows (21a, 21b) hung/fixes the metal arrows (20a, 20b) and makes the metals arrows (20a,20b) ready to support the springs system in a fully compression/charging position. The foot lever (14) and hydraulic jack (17) transfers and amplifies the human body external force (19) to compress/charges the stored energy in the springs system via the U shape metal frame (18). The metals arrows (20a, 20b) supports/fixes the springs system after fully compression/charging (fully charging position), wherein the metals arrows (20a, 20b) ready to release the springs system in response to an external pushing force applied to the release push button (15). The compression/charging mechanical mechanism manually returned back to its normal position after full compression of the springs system that hanged and fixed by the support/release mechanical mechanism. The release push button (15) moves forward in response to an external force and rotates the metal arrows (21a, 21b) in clockwise direction which releases the metal arrows (20a, 20b) and releases the springs system as a consequence. The released stored energy of the springs system moves the springs system in linear oscillation (extension/compression) movement and swings in the metal rail (25) via the bearings (24a, 24b). the linear oscillation (extension/compression) movement of the springs system coupled to and drives the permanent magnet armature (6) in linear velocity inside the stator (7) and generates an output alternating electric power at the terminals of the stator insulated copper windings (9), Wherein the frequency of the output alternating electric power equal to the frequency/oscillation (extension/compression) movement of the springs system. The output power feeds/supplies the main electric convertor (12) and the supplementary electric rectifier (16a) via the electric circuit breaker (10) and the insulated copper wires (3a). The main electric convertor (12) converts and regulates the output electric power (frequency and voltage) to match and feed the electric loads, at the same time The supplementary electric rectifier (16a) rectifies/converts the output alternating electric into D.C. electric power that feeds/charges the supplementary Battery (16b). The supplementary Battery (16b) feeds the linear D.C. electric motor (1) via the electric regulator (16) and micro switch (16c), wherein the D.C. electric power feeds the linear D.C. electric motor (1) in a accordance to the operation of the micro switch (normally open) (16c).

After releasing the springs system and starts linear extension from above to below, the movable metal plate (5) pushes the lead of the micro switch (16c) and closes the electric circuit that feeds the linear D.C. electric motor. the regulated D.C. current direction (3d) in the linear D.C. electric motor (1) generates a magnetic field pushing force that pushes the shafts (4) forward (from above to below). Since the linear D.C. electric motor (1) is fixed to the housing frame (2a) and his movable shaft (4) fixed to and parts of the springs system, the magnetic field pushing force pushes and enhances/supplements the extension movement of the springs system from above to below. When the springs system reaches the maximum extension (maximum displacement) wherein the instantaneous velocity of the springs system and coupled the permanent magnet armature (6) equal zero, There is no generated voltage produced at the stator insulated copper windings terminals (9). The springs system reverses his direction movement and starts compression toward the linear D.C. electric motor (1) due to springs force. The electric voltage and current are generated at the terminals of the stator insulated copper windings (9) in reversed direction. When the spring system arrangement reaches maximum compression position, wherein the micro switch (16c) fixed position to the housing frame, the metal plate (5) pushes the lead of the micro switch (16c) and closes the electric circuit that feeds the linear D.C. electric motor. the regulated D.C. current direction (3d) in the linear D.C. electric motor (1) generates a magnetic field pushing force that pushes the shafts (4) backward (from above to below). Since the linear D.C. electric motor (1) is fixed to the housing frame (2a) and his movable shaft (4) fixed to and parts of the springs system. The springs system reverses his direction movement and starts extension backward the linear D.C. electric motor (1) due to springs force and generated magnetic field pushing force. The magnetic field pushing force associated with springs force pushes and enhances/supplements the extension movement of the springs system from above to below. The electric voltage and current are generated at the terminals of the stator insulated copper windings (9) is reversed the direction.

In other word, the generated pushing force works/acts in accordance to operation of the micro switch (16c) as an applied vibrated force to the springs system with a frequency in line with the natural frequency of the springs system after releasing to enhance his linear oscillation (extension and compression) movement and puts the springs system under continuous linear oscillation (extension and compression) movement.

To stop the operation of the present invention system, the hand leaver or the push button of the circuit breaker (1) and supplementary electric regulator (16) has to change manually from ON position to OFF position.

FIG. (2B) 2/15 and FIG. (3B) 3/15 presents the present invention system (a self-sustain electric power generating system) fully compression/charging condition (fully compression/charging position).

FIG. (4/15) presents the simulated sample representing the springs system response and characteristic of the present invention system (a self-sustain electric power generating system).

FIG. (5/15) presents the illustrated formulas represent the simulated sample/springs system response and characteristic of the present invention system.

The formulas represent the spring system arrangement under damping vibration force and effects of the external applied vibration force (Fcoswt).

The followings are the conclusions from FIG. (4) and FIG. (5).
1. The continuous oscillation of the springs system.
The springs system under damped force vibration (after releasing) continuous in oscillation if an external vibrated force (Fcoswt) applied to the springs system has frequency (W) equal or less than the springs system overall natural frequency (Wn).
2. The displacement of the springs system.
The displacement of the springs system coupled/connected to the permanent magnet armature (6) of the linear electric generator in accordance to (depend on) the mass of the springs system includes the coupled/connected permanent magnet armature (6) mass, the magnitude of the applied force and the overall springs stiffness (k), if we consider that the frequency ratio (W/Wn) is constant and in certain value equal or less than one.

FIG. (6/15) presents the supplementary linear D.C. electric motor of the present invention system. The supplementary linear D.C. electric motor converts the electric power into pushing force in response to the output voltage of the supplementary Battery (16b) that feeds the linear D.C. electric motor (1) in a accordance to operation of the micro switch (16c) and the current direction flows in the linear D.C. electric motor (1).

FIG. (6A) shown that the generated pushing force of the linear D.C. electric motor (1) generates in a accordance to operation of the micro switch (16c) that operates in response to pushing force generated by the movement of the movable metal plate (5) above the lead of the micro switch (16c) that closes the electric circuit feeds the linear D.C. electric motor in the current flow direction (3d) and applied voltage (3). The generated pushing force of the linear D.C. electric motor (1). Push/makes the springs system to move backward the linear D.C. electric motor (1). In the present invention system the linear D.C. electric motor (1) fixed to the fixed housing frame (2a) and his movable shaft (4) is fixed and part of the springs system. The permanent magnet linear electric generator works as a voltage source (3) that generate a voltage and current supplies/charges the supplementary Battery. The voltage and current direction (3d) that feeds the linear D.C. electric motor (1) in response to the supplementary battery (16b) voltage, while the direction of the generated voltage source (3) in accordance to the movement direction of the permanent magnet armature (6) of the linear electric generator. The Generated pushing forces push/makes the springs system to move backward the fixed linear D.C. electric motor (1).

FIG. (6B) shown that the movable shaft of the linear D.C. electric motor is reversed the movement direction due to the springs force. The springs force pulls/makes the springs system to move forward the linear D.C. electric motor (1) and the micro switch (16c) fixed to housing frame in line with the maximum compression position of the springs system (movable metal plate (5)). In the present invention system the linear D.C. electric motor (1) fixed to the fixed housing frame (2a) and his movable shaft (4) is fixed and part of the springs system.

FIG. (7/15) presents the sequence and operation method of the present invention system for generating electric power, the direction (frequency) of the generated electric power and the direction (frequency) of the generating pushing force applied to the springs system.

FIG. (7A) shown that the spring system arrangement under steady state position (normal position). (There is no generated voltage and no current produced in the stator insulated copper windings terminals (9)).

FIG. (7B) shown that the spring system arrangement under fully compression position (ready for release position). (There is no generated voltage and no current produced in the stator insulated copper windings terminals (9)).

FIG. (7C) shown that the spring system arrangement is released and starts linear extension movement. A generating voltage and current produced in the stator insulated copper windings terminals (9). The generated current feeds the electric rectifier and electric loads, at the main time the movable metal plate (5) of the springs system moves from above to below toward the micro switch lead, the movable metal plate (5) reaches and pushes the lead of the micro switch (16c) and closes the electric circuit feeds the linear D.C. electric motor in a current flow direction (3d). the Linear D.C. electric motor converts the D.C. electric power into magnetic field pushing force that pushes the shafts (4) backward the linear D.C. electric motor (from above to below). Since the linear D.C. electric motor (1) is fixed to the housing frame (2a) and his movable shaft (4) fixed to and parts of the springs system, the magnetic field pushing force pushes and enhances/supplements the extension movement of the springs system. A generated pushing force pushes/accelerates the springs system movement backward the fixed linear D.C. electric motor (1). The generated pushing force and its direction acts in line with the linear movement direction (frequency) of the springs system.

FIG. (7d) shown that the movable metal plate (5) exceeds the micro switch (16c) that opens the electric circuit feeds the linear D.C. electric motor and the springs system reaches the maximum extension (maximum displacement), wherein the instantaneous velocity of the springs system and the connected/coupled permanent magnet armature (6) equal zero. (There is no generated voltage and no current produced in the stator insulated copper windings terminals (9)).

FIG. (7E) shown that the springs system reverse his direction toward the linear D.C. electric motor (1) and micro switch (16c) due to springs force. The electric voltage and current are generated in reversed direction at the terminals of the stator insulated copper windings (9). The micro switch (16c) still opening the electric circuit that feeds the linear D.C. electric motor (1) and no current feeds the linear D.C. electric motor (1).

FIG. (7F) shown that the movable metal plate (5) reaches and pushes the micro switch (16c) lead And the springs system reaching the maximum compression (maximum charging) when the instantaneous velocity of the springs system and the connected/coupled permanent magnet armature (6) equal zero. (There is no generated voltage and no current produced in the stator insulated copper windings terminals (9)). The micro switch (16c) closes the electric circuit that feeds the linear D.C. electric motor (1) in a current flow direction (3d). the Linear D.C. electric motor converts the D.C. electric into magnetic field pushing force that starts push the shafts (4) backward (from above to below). Since the linear D.C. electric motor (1) is fixed to the housing frame (2a) and his movable shaft (4) fixed to and parts of the springs system, the magnetic field pushing force starts push and enhance/supplement the extension movement of the springs system.

FIG. (7G) shown that the springs system reverse his direction backward the linear D.C. electric motor (1) due to springs force and magnetic field pushing force. The electric voltage and current are generated in the terminals of the stator insulated copper windings (9). The movable metal plate (5) exceeds the micro switch (16c) that opens the electric circuit feeds the linear D.C. electric motor.

FIG. (8/15) presents a flow chart representation the method of the present invention system (a self-sustaining electric power generating system).

In step (801) energy is stored in springs system (one time only at starting) via compression/charging mechanical mechanism in response to external force.

In step (802) energy stored in springs system having an input for charging the stored energy (one time only at starting) in response to external force and an output for releasing the stored energy (one time only at starting) in response to external force.

In step (803) the stored energy in springs system is released via support and release mechanical mechanism that generates a released signal for releasing the stored energy in springs system in response to external force.

In step (804) the springs system is extending and compressing in linear movement after releasing the stored energy, wherein the springs system drives the armature of the linear electric generator in linear movement (velocity).

In step (805) a permanent magnet linear electric generator converts the stored energy/linear extension and compression movement of the spring's system into output alternating electric power.

In step (806) the output electric power is converted and regulated via electric convertor to feeds and matches the electric loads.

In step (807) the electric loads powered via electric convertor.

In step (808) the output alternating electric power is rectified/converted into D.C. electric power via supplementary electric rectifier to feeds/charges storage energy equipment (Battery).

In step (809) the supplementary battery feeds the linear D.C. electric motor via supplementary electric regulator and micro switch.

In step (8010) the micro switch operates (connecting & disconnecting) in accordance to the movement (extension and compression) of the springs system, wherein the operating of the micro switch closes the electric circuit that feeds/supplies the linear D.C. electric motor.

In step (811) the linear D.C. electric motor converts the regulated electric power into output pushing force applied to the springs system in accordance to the operation of micro switch that operates in response to pushing force generated by the movement of the springs system. Wherein the pushing applied force has a frequency equal to the natural frequency of the oscillated springs system (extension movement) after releasing for continuous linear oscillation (extension and compression) movement of the springs system and continues generating of output electric power as a result.

FIG. (9/15) presents model (B) of the present invention system.

Model (B) is the innovated model of model (A).

Model (B) has the same method of operation, duty, function and parts/equipments of model (A) plus extra six springs (27a, 27b, 27c, 27d, 27e, 27f). The extra six springs (27a, 27b, 27c, 27d, 27e and 27f) increases the overall spring's stiffness (K), the frequency of the linear oscillation movement of the springs system and the generated voltage frequency at the terminals of the stator insulated copper windings (9).

NOTE: all arrows shown in the figures/drawings are just for indication of the supplementary currents direction after releasing the springs from up to down and pushing the micro switch (16c) lead. For the actual current flow direction, Please refer to FIG. 7/15

FIG. (10/15) presents model (C) of the present invention system.

Model (C) is the innovated model of model (A). Model (C) has the same method of operation, duty, function and parts/equipments of model (A) plus extra springs system and Linear D.C. electric motor (1b) fixed on the button of the housing frame. The extra springs system connected/coupled to end side of the permanent magnet armature (6) and movable plate (5b). The extra springs system increases the overall spring's stiffness (K), the frequency of the linear oscillation movement of the springs systems and the frequency of the generated g voltage at the terminals of the stator insulated copper windings (9). The extra Linear D.C. electric motor (1b) represents additional force source applied to the springs systems to increase the stability and efficiency of the system. While the springs system (top side) under magnetic pushing force produced by Linear D.C. electric motor (1a) after the releasing, the springs system (button side) under magnetic pulling force produced by Linear D.C. electric motor (1b).

NOTE: all arrows shown in the figures/drawings are just for indication of the supplementary currents direction after releasing the springs from up to down and pushing the micro switch (16c) lead. For the actual current flow direction, Please refer to FIG. 7/15

FIG. (11/15) presents model (D) of the present invention system.

Model (D) is the innovated model of model (A). Model (D) has the same method of operation, duty, function and parts/equipments of model (A) plus flywheel (29). The flywheel (29) fixed to the housing frame (2c). The flywheel (29) converts the linear movement of the springs system into rotation movement. The rotation movement of the flywheel (29) drives and rotates the gear box (30) shaft. The gear box output shaft rotation movement drives and rotates the rotational electric generator (31). The electric generator (31) represents an additional electric power source feeds extra electric loads through additional main electric convertor.

NOTE: all arrows shown in the figures/drawings are just for indication of the supplementary currents direction after releasing the springs from up to down and pushing the micro switch (16c) lead. For the actual current flow direction, Please refer to FIG. 7/15

FIG. (12/15) presents model (E) of the present invention system.

Model (E) is the innovated model of model (A).

Model (E) has the same method of operation, duty, function and parts/equipments of model (A) plus extra one permanent magnet linear electric generator, additional Linear D.C. electric motor (1b). The extra one permanent magnet linear electric generator represents an additional electric power source feeds extra electric loads through the main electric convertor (12b).

NOTE: all arrows shown in the figures/drawings are just for indication of the supplementary currents direction after releasing the springs from up to down and pushing the micro switch (16c) lead. For the actual current flow direction, Please refer to FIG. 7/15

FIG. (13/15) presents model (F) of the present invention system.

Model (F) is the innovated model of model (A). Model (F) has the same method of operation, duty, function and parts/equipments of model (A) plus extra eight springs (28a, 28b, 28c, 28d), (29a, 29b, 29c, 29d) and movable plate (5b). The extra eight springs increases the overall spring's stiffness (K), the frequency of the linear oscillation movement of the springs system and the generated voltage frequency at the terminals of the stator insulated copper windings (9). The extra movable metal plate (5b) includes two bearings swings in rail fixed inside hosing frame. The movable metal plate (5b) connected to end side of the armature (6) and to the extra eight springs (28a, 28b, 28c, and 28d), (29a, 29b, 29c, and 29d). The compression mechanism inside the housing frame pulls down the movable metal plate (5b) via external force and fixed via support/release mechanism.

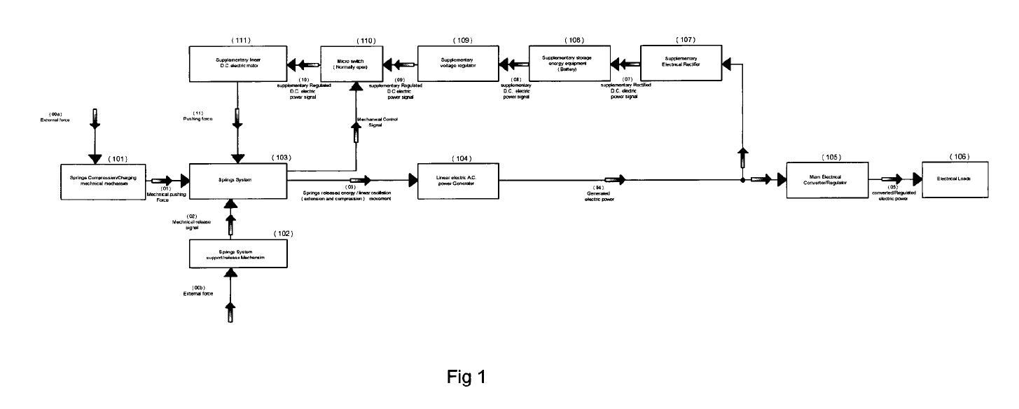

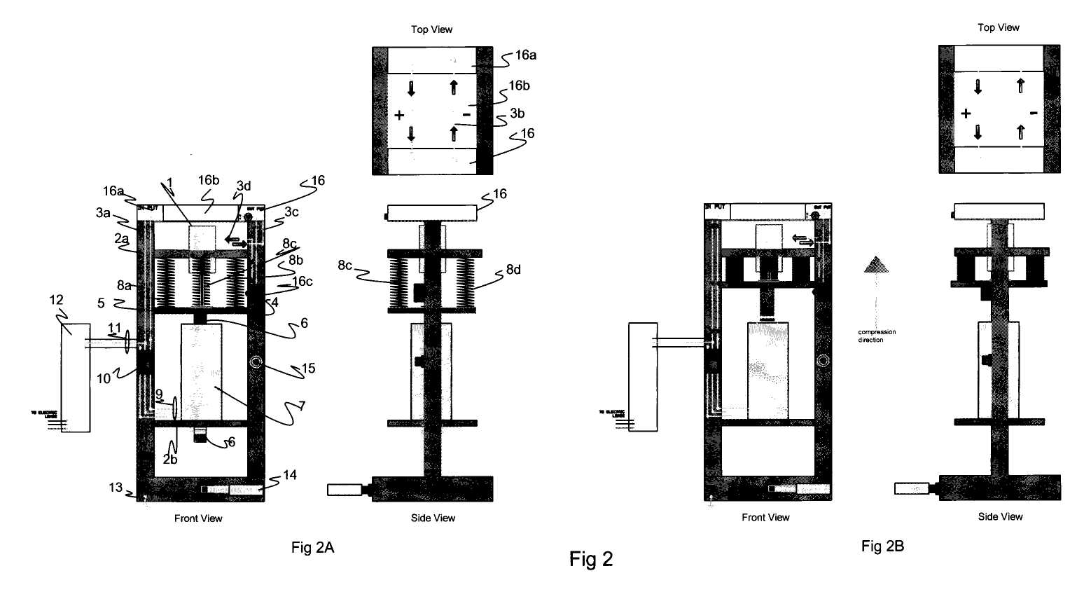

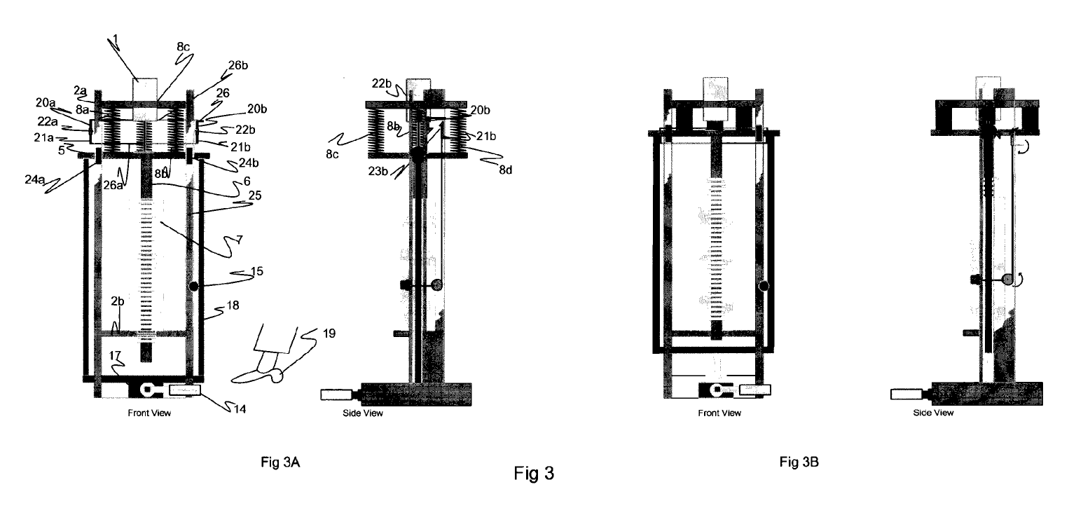

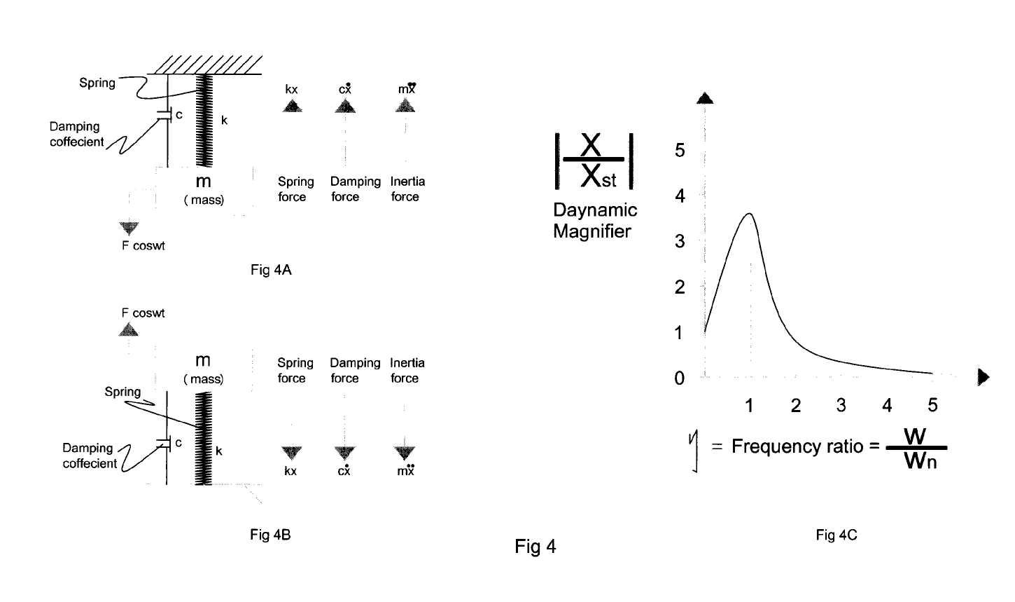

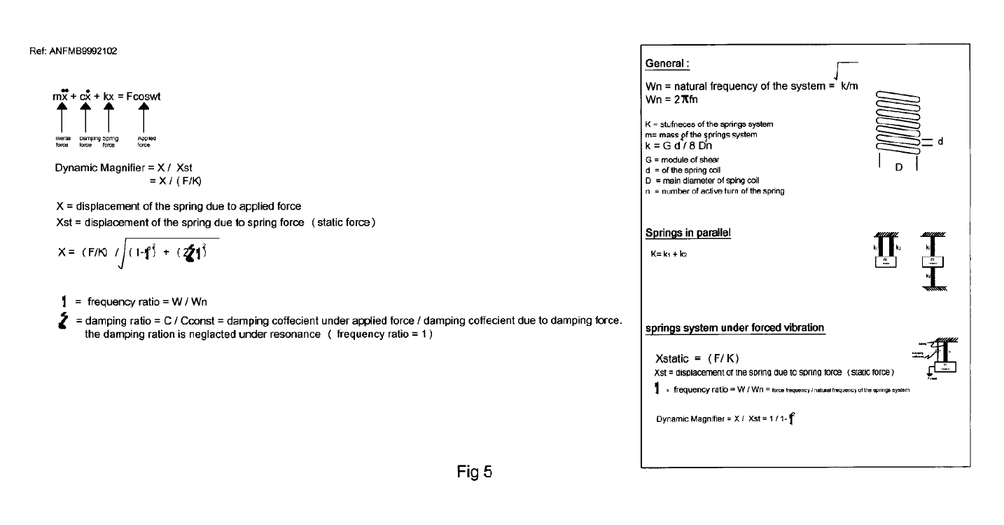

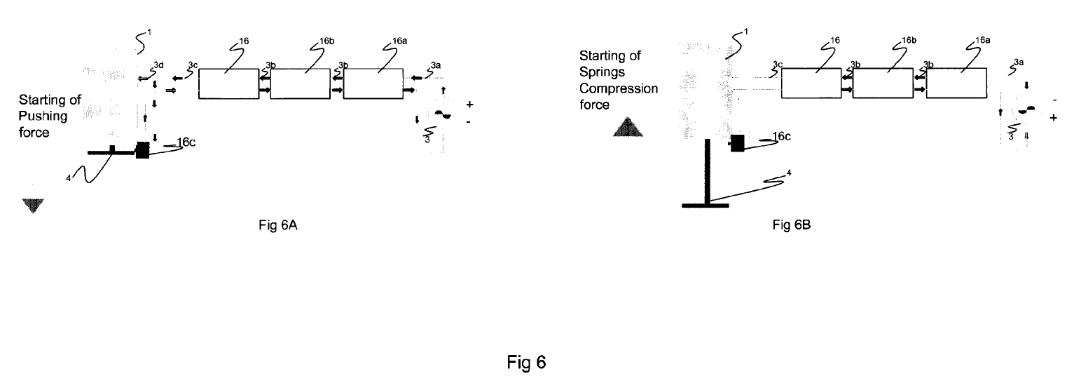

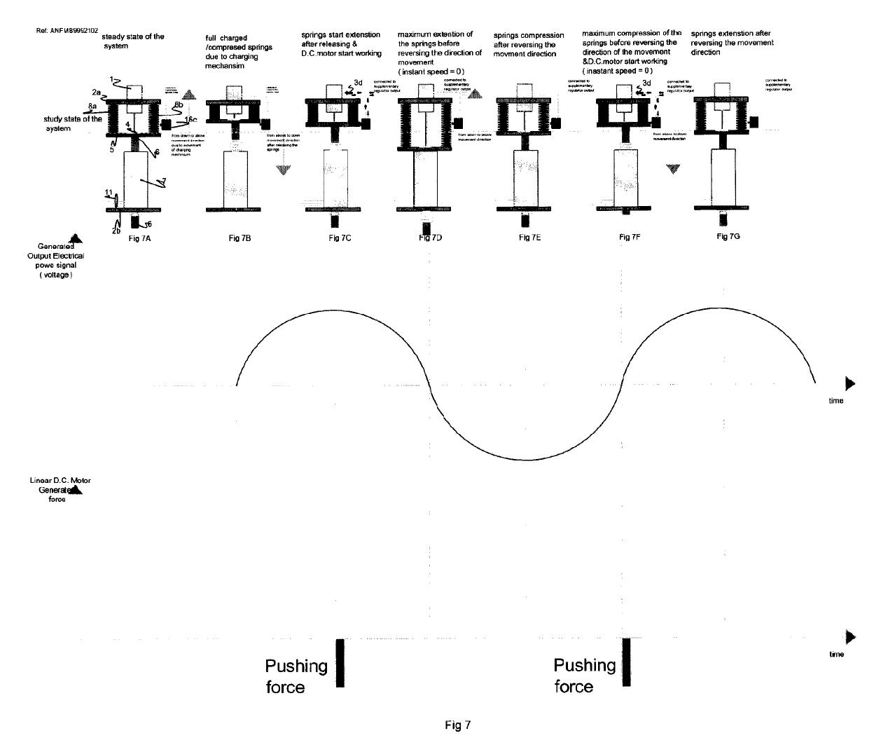

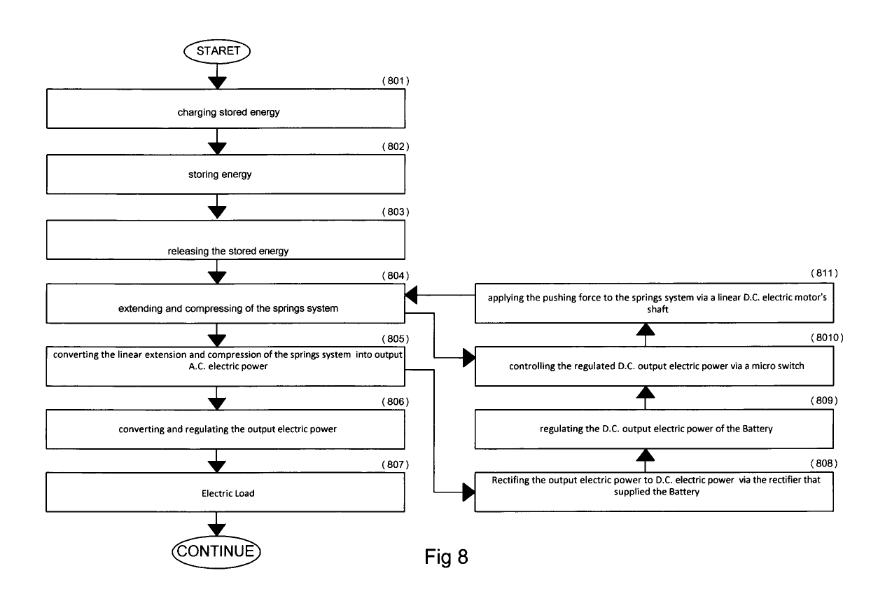

the discharged/released energy of the springs makes the movable metal plates (5a & 5b) moves up from down to top and the two bearings (24a, 24b) of the movable metal plate (5a) and other two bearings of the movable metal plate (5b) swings in fixed metal rail (25) (see FIG. 3)) and the springs system moves in linear extension and compression movement.

NOTE: all arrows shown in the figures/drawings are just for indication of the supplementary currents direction after releasing the springs from down to up and pushing the micro switch (16c) lead. For the actual current flow direction, Please refer to FIG. 7/15.

FIG. (14/15) presents model (G) of the present invention system.

Model (G) is the innovated model of model (A).

Model (G) has the same method of operation, duty, function and parts/equipments of model (A) But, with new mechanical support and release mechanism (15 & 15a) and extra springs (8e & 8f). The hydraulic jack lead (17a) directly pushes the permanent magnet armature (6) and compresses/extension the springs which supported and released via the mechanical support and release mechanism (15a) includes the release push button (15).

NOTE: all arrows shown in the figures/drawings are just for indication of the supplementary currents direction directly after releasing the springs from down to up until reaching the maximum extension and compression of the springs. For the actual current flow direction, Please refer to FIG. 7/15

FIG. (15/15) presents one of the application and function of the present invention system which can arranged/assembled and used for generating a big amount of electric power with compact structure design used as an electric engine stores electric power in the storage system (batteries (32)) for drive electric cars that includes electric drive motors. The electric engine shown that includes multi self-sustaining electric power generator (33) equipped with screw jack compression/charging mechanism (34). All the electric power generator (33) is compressed/connected to one supporting/housing frame (35). the D.C. drive motor (36) drives all the compression/charging mechanism (34) of each electric power generator (33) via a rotating shaft (37) and transducer chine (38). The D.C. drive motor (36) is connected to D.C. power source (32). The Engine charging push button electric switch (39) makes the D.C. motor (36) starts rotate and start compression/charging each electric power generator (33) and reverse his rotation direction and return to the normal position in accordance to monitor signal generated by the control timer built in the motor control panel (40) or any types of sensor after fully compression/charging of the springs in each electric power generator (33). The built-in electromechanical support/release mechanism releases the springs system of each electric generator (33) in accordance to control signal generated by the engine starting push button electric switch (42) that distributed and connected to each electric power generator (33) via the distribution box (41). the multi input convertor (43) converts and regulates the generating electric power and feeds it to the energy storage equipment (battery (32)).

1. An energy storage and drive device, comprising:
one or more springs coupled to a mass and configured to store and release energy;
a compression mechanism for charging the one or more springs with energy to be stored and released by the charged one or more springs;
a support and release mechanism for supporting and fixing the charged one or more springs at a fully charged position and releasing the charged one or more springs in response to an external release signal;
a supplementary drive for applying an external force on the mass once the charged one or more springs are released by the support and release mechanism so as to create resonance within the one or more springs; and
an electric generator coupled to the mass for converting the energy released by the one or more springs through the mass into electric energy.

2. An energy storage and drive device as recited in claim 1, wherein the electric generator includes a rotor and a shaft for driving the rotor, wherein the support and release mechanism includes a main frame to which one side of the one or more springs are fixed, and wherein another side of the one or more springs is coupled to the mass that drives the shaft of the electric generator in linear velocity or in rotational velocity via a linear to rotational motion transducer.

3. An energy storage and drive device as recited in claim 1, wherein the compression mechanism includes a jack/hydraulic system for charging the one or more springs with energy via an external energy force coupled to an input of the jack/hydraulic system.

4. An energy storage and drive device as recited in claim 1, wherein the supplementary drive is a linear electric motor or solenoid, further comprising:
a sensor for monitoring an instantaneous velocity of the one or more springs and producing a control signal;
an external energy source for producing an electric power signal for powering the supplementary drive;
an electric regulator for receiving the electric power signal and generating a regulated electric power signal; and
a micro switch for receiving the control signal from the sensor and for receiving the regulated electric power signal and connecting and disconnecting the regulated electric power signal to the supplementary drive that applies the external force to the mass.

5. An energy storage and drive device as recited in claim 4, wherein the linear electric drive or solenoid applies the external force to the mass via a movable shaft at a (frequency substantially in phase with a natural frequency of oscillation of the one or more springs coupled to the mass after the one or more springs are released.

6. An energy storage and drive device as recited in claim 4, wherein the micro switch connects the regulated electric power signal to the linear electric drive or solenoid when the sensor detects the instantaneous velocity of the one or more springs is zero.

7. An energy storage and drive device as recited in claim 1, wherein the mass drives the electric generator in linear velocity or in rotational velocity via linear to a rotation motion transducer.

8. An energy storage and drive device as recited in claim 1, wherein the supplementary drive is a mechanical source applied directly to the mass via a mechanical mechanism.

9. An energy storage and drive device as recited in claim 1, wherein the energy in the one or more springs is kinetic and potential energy, and wherein the electric generator converts the kinetic and potential energy into electric energy during a load condition.

10. An energy storage and drive device as recited in claim 5, wherein the natural frequency of oscillation of the one or more springs coupled to the mass is increased/decreased by increasing/decreasing a number of the one or more springs, an overall stiffness (K) of the one or more springs, or the coupled mass.

11. An energy storage and drive device as recited in claim 1, wherein the electric energy capacity of the device is increased by increasing a number of one or more springs in parallel, increasing an overall stiffness (K) of the one or more springs or reducing the coupled mass.

12. An energy storage and drive device as recited in to claim 1, wherein the device is connected to an electric network for storing energy from the electric network inside the one or more springs at off-peak demand of the electric network and releasing energy to the electric network during peak demand of the electric network.

13. A method comprising:
storing energy inside one or more springs coupled to a mass by compressing the one or more springs with an external energy force;
releasing the one or more springs to release the stored energy;
applying a periodic force to the mass and the one or more springs at a frequency substantially equal to a natural resonant frequency of the one or more springs and the mass after the one or more springs are released to create a resonance phenomenon within the one or more springs; and
converting the energy released by the one or more springs into electric energy during a Load condition.

14. An energy storage and drive device as recited in claim 1, wherein the one or more springs and the mass are fixed inside a vacuum compartment or gas compartment to reduce energy loss during motion of the one or more springs and the mass.

15. An energy storage and drive device as recited in claim 3, wherein the external energy force is a renewable energy source.

16. An energy storage and drive device as recited in claim 3, wherein the external energy force is a human source.

17. An energy storage and drive device as recited in claim 3, wherein the external energy force is a vehicle source.
